(19) United States
(12) Patent Application Publication
(10) Pub. No.: US 2012/0323634 A1
(43) Pub. Date: Dec. 20, 2012

(54) APPARATUSES, METHODS AND SYSTEMS FOR A MEDIA MARKETING PLANNING AND OPTIMIZATION TOOL

(75) Inventors: Jason E. Harper, Ann Harbor, MI (US); Stephen F. Kerho, Los Angeles, CA (US); Jonathan P. Prantner, Oswego, NY (US); Joseph P. DiMeglio, Rochester Hills, NY (US)

(73) Assignee: Organic, Inc., San Francisco, CA (US)

(21) Appl. No.: 13/383,867

(22) PCT Filed: Jul. 15, 2010
(86) PCT No.: PCT/US10/42167

§ 371 Date: Aug. 31, 2012

Related U.S. Application Data
(60) Provisional application No. 61/225,886, filed on Jul. 15, 2009.

(51) Int. Cl. G06Q 30/02

(52) U.S. Cl. 705/7.31

(57) ABSTRACT

This disclosure details the implementation of apparatuses, methods, and systems for a media marketing planning and optimization tool (hereinafter, “MMPO TOOL”). MMPO TOOLs implement a live application whereby users may obtain sales forecast data and media planning information by submitting client specific data, such as historic sales data, media spend data, incentive/promotion data, and/or the like, to the MMPO TOOL.

### RELATED APPLICATIONS

The instant application claims priority under 35 USC §119 for U.S. provisional patent application Ser. No. 61/225,886, filed Jul. 15, 2009, entitled “APPARATUSES, METHODS AND SYSTEMS FOR A MEDIA MARKETING PLANNING AND OPTIMIZATION TOOL,” attorney docket no. 19392-004PV.

### FIELD

The present invention is directed generally to an apparatuses, methods, and systems to analyze media effectiveness, and more particularly, to APPARATUSES, METHODS AND SYSTEMS FOR A MEDIA MARKETING PLANNING AND OPTIMIZATION TOOL.

### BACKGROUND

Corporations market to consumers using various media. The three most popular media types are TV, print, and Internet. Many manufacturers have realized a positive impact of media advertising on the product sales. Expenses of media marketing may be significant. For example, it may cost $200,000 for one 30-second commercial on a major TV channel during prime-time.

### SUMMARY

The APPARATUSES, METHODS AND SYSTEMS FOR A MEDIA MARKETING PLANNING AND OPTIMIZATION TOOL (hereinafter “MMPO TOOL”) provides a live application whereby users may obtain sales forecast data and media planning information by submitting client specific data, such as historic sales data, media spend data, incentive/promotion data, and/or the like, to the MMPO TOOL. In one embodiment, a method is disclosed, comprising: receiving macro economic data from at least one third party data source; combining the received macro economic data into at least one principal economic factor; receiving client specific data from at least one user; establishing a sales forecast structure by regression based on the at least one principal economic factor and the received client specific data; generating sales forecast data based on the established sales forecast structure; and developing client specific media marketing plan.

### BRIEF DESCRIPTION OF THE DRAWINGS

The accompanying appendices and/or drawings illustrate various non-limiting, example, inventive aspects in accordance with the present disclosure:

FIG. 1A is of a block diagram illustrating an overview of an implementation of data flow between a Media Marketing Nanning and Optimization Tool (hereinafter “MMPO TOOL”) and affiliated entities in one embodiment of the MMPO TOOL;

FIG. 1B is of a block diagram illustrating an example structure of MMPO TOOL components within one embodiment of the MMPO TOOL;

FIG. 2 shows a diagram of data flows for implementing the MMPO TOOL in one embodiment of the MMPO TOOL;

FIG. 3A-3D show logic flow diagrams for implementing the MMPO TOOL within embodiments of the MMPO TOOL;

FIG. 4A-4E provide examples of sales forecast data sheet and curve plots within embodiments of the MMPO TOOL; and

FIG. 5 is of a block diagram illustrating embodiments of the MMPO TOOL controller;

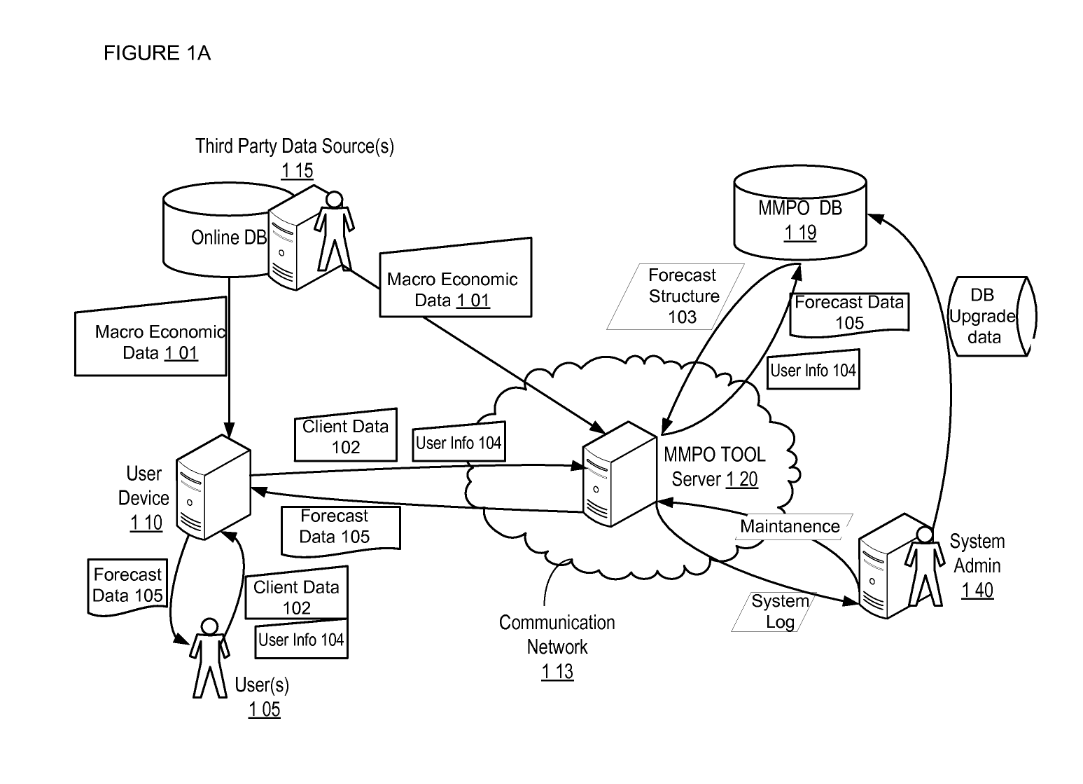

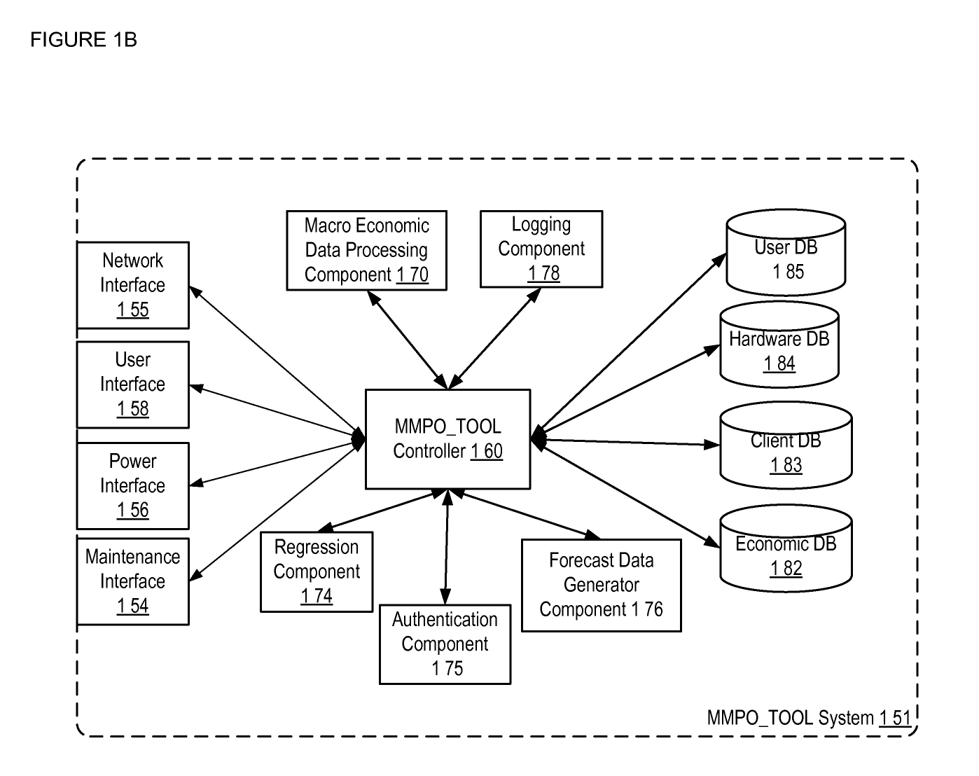

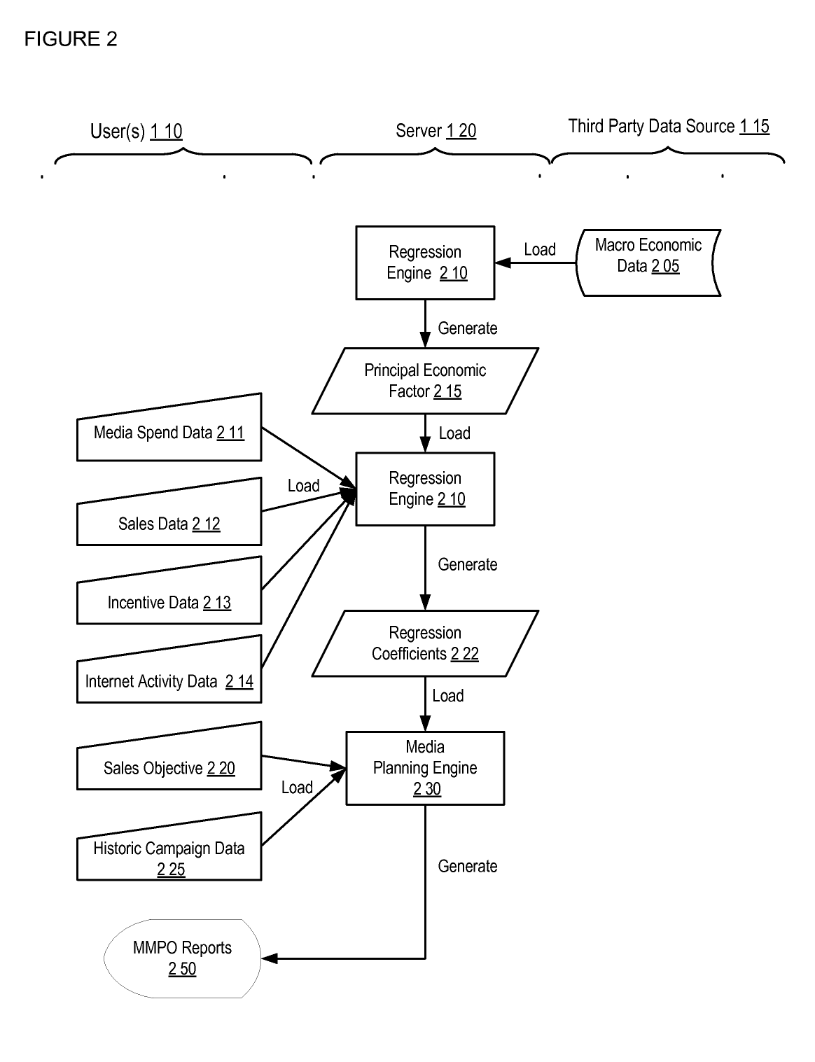

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

This disclosure details the implementation of apparatuses, methods, and systems for a media marketing planning and optimization tool (hereinafter, “MMPO TOOL”). MMPO TOOL implements a live application whereby users may obtain sales forecast data and media planning information by submitting client specific data, such as historic sales data, media spend data, incentive/promotion data, and/or the like, to the MMPO TOOL.

For example, in some embodiments, for vehicle industry, the MMPO TOOL may obtain related data from a variety of sources, including macro economic data such as gas prices, new housing starts, unemployment rate, prime interest rate, mortgage rate, S&P 500, consumer sentiment, M2 Money Stock, PMI Composite Index, total consumer credit outstanding, personal income, personal savings, and/or the like; client sales data; client media spend data, such as media spend in different media types, media spend in a specific TV channel, etc; incentive/promotion data; Internet activity data, and/or the like. The MMPO TOOL may employ regression techniques to calculate sales forecast structure coefficients, and generate forecast data based on the structures with calculated coefficients. In one implementation, based on the forecast data, the MMPO TOOL may determine a minimum amount of media spend for a sales objective submitted by a user; on the other hand, the MMPO TOOL may also provide sales and/or web visits (e.g., visits of the client company website, visits of client product online stores, etc.) forecast data based on a media spend budget. In one implementation, the MMPO TOOL may analyze the generated forecast data, e.g. in one implementation, calculate the Return on Media Investment (ROMI) value, and suggest a media spend range of the most desirable ROMI value.

In one embodiment, the MMPO TOOL may also determine a value of each Internet activity, i.e. a dollar value reflecting the net contribution of a specific Internet activity to the sales. For example, in one implementation, the MMPO TOOL may obtain sales data and Internet activity data, and determine that a Household Lead is worth $827.26, a Dealer Locate is worth $89.44, a Build and Price Visit is worth $2.62, a Search Inventory Visit is worth $1.35. In one implementation, the MMPO TOOL may return the values to the user for the purpose of optimizing website design and management.

It is to be understood that, depending on the particular needs and/or characteristics of a MMPO TOOL user, administrator, server, data payload, monetization structure, hardware configuration, network framework, and/or the like, various embodiments of the MMPO TOOL may be implemented that enable a great deal of flexibility and customization. The instant disclosure discusses embodiments of the MMPO TOOL primarily within the context of media marketing planning and optimization. However, it is to be understood that the system described herein may be readily configured/customized for a wide range of other applications or implementations. For example, aspects of the MMPO TOOL may be adapted for inventory investment planning, transportation expense planning, and/or the like. It is to be understood that the MMPO TOOL may be further adapted to other implementations for manufacturing management applications.

FIG. 1A is of a block diagram illustrating a MMPO TOOL. In FIG. 1, a user (or users) 1-5, user device(s) 110, a MMPO TOOL server 120, third party data source(s) 115, a MMPO database 119, and a system administrator 140 are shown to interact via a communication network 113. The user 105 may operate a wide variety of different user devices 110, including communications devices and technologies within embodiments of MMPO TOOL operation. For example, in one embodiment, the user devices 110 may include, but are not limited to, computer terminals, work stations, cellular telephony handsets, blackberries, PDAs, and/or the like. In one embodiment, the MMPO TOOL server 120 may be equipped at a terminal computer of the user 110. In another embodiment, the MMPO TOOL server 120 may be a remote server which is accessed by the user 110 via a communication network 113, such as, but not limited to local area network (LAN), in-house intranet, the Internet, and/or the like.

In one embodiment, the user 105 may submit client data, such as, but not limited to sales data, media spend data, incentive/promotion data, Internet activity data, and/or the like, to the MMPO TOOL server 120 via the user device 110 through the communication network 113. In another embodiment, the user 105 may also provide user specified model parameters for forecast, such as but not limited to client desired media spend, client desired profit and return, and/or the like. In another embodiment, the MMPO TOOL server may obtain macro economic data from third party data source(s) 115, e.g. public accessed websites, online databases, consulting companies, etc. In one implementation, the use 105 may obtain macro economic data from a third party data source 115 (e.g., a consulting company report, user downloaded Internet data, etc.) and upload it to the MMPO TOOL server 120.

In one implementation, the user 105 (via the user device 110) may also submit configuration data to the MMPO TOOL 120 to establish and/or modify user-specific system settings. In one implementation, the MMPO TOOL server 120 may send generated MMPO reports to the user 110 via the communication network 113. For example, in one implementation, the MMPO TOOL server 120 may generate an MMPO report in pdf format and send it to the user via electronic mails. In another implementation, the MMPO TOOL server 120 may display the MMPO report to the user on the computer screen.

In one embodiment, the MMPO TOOL server 120 may also communicate with a MMPO database 119. In some embodiments, a MMPO server 120 may be integrated with a local MMPO TOOL database 119. In other embodiments, a MMPO TOOL server 120 may access a remote MMPO database 119 via the communication network 113. The MMPO TOOL server 120 may send obtained/generated data to the database 119 for storage, such as, but not limited to user account information, project information, client data associated with a project, macro economic data, generated forecast data and/or the like. In another implementation, the MMPO TOOL may retrieve forecast model stored in the MMPO database.

In one embodiment, a system administrator 140 may communicate with the MMPO TOOL server 120 and the MMPO database 119 for regular maintenance, service failure, system updates, database renewal, and/or the like. In one embodiment, the system administrator 140 may directly operate with the MMPO TOOL server 120 and the MMPO database 119 on an in-house basis, such as, but not limited to via an integrated administrator user interface. In another embodiment, the system administrator 140 may remotely access the MMPO TOOL server 120 and the MMPO database 119 and perform its functionality via the communication network 113.

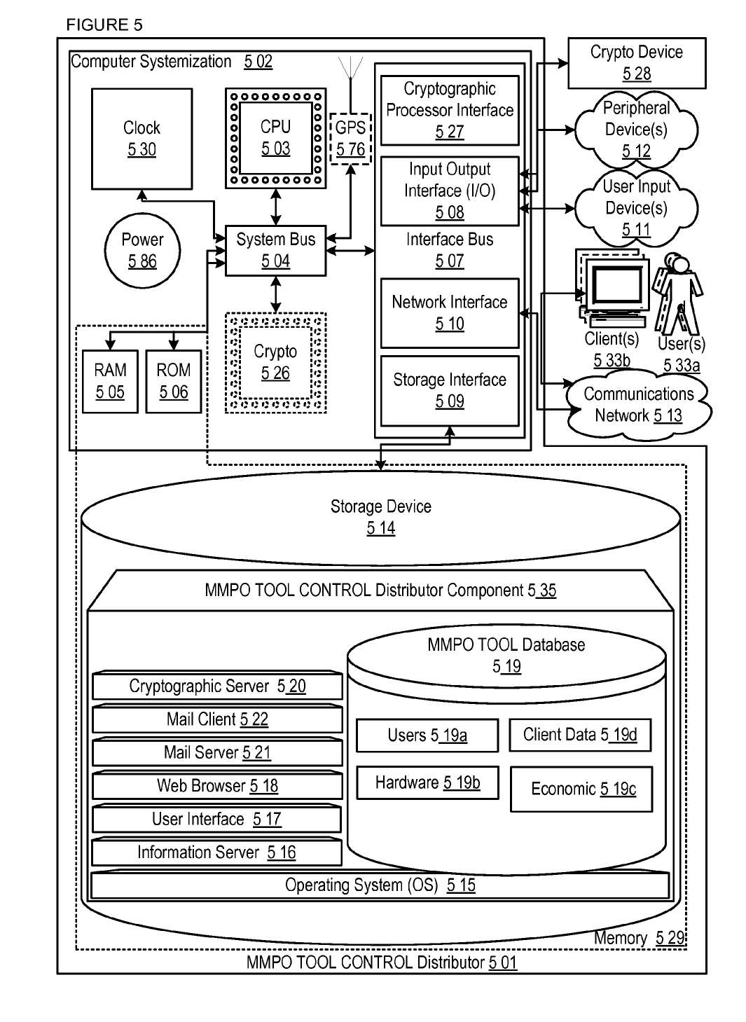

FIG. 1B shows an implementation of MMPO TOOL system components in one embodiment of MMPO TOOL operation. The MMPO TOOL system 151 may contain a number of functional components and/or data stores. A MMPO TOOL controller 160 may serve a central role in some embodiments of MMPO TOOL operation, serving to orchestrate the reception, generation, modification, and distribution of data and/or instructions, to, from, and between MMPO TOOL components and/or mediate communications with external entities and systems. Further example details with regard to the MMPO TOOL controller 160 is provided in FIG. 5.

In one embodiment, the MMPO TOOL controller 160 may be housed separately from other modules and/or databases within the MMPO TOOL system, while in another embodiment, some or all of the other modules and/or databases may be housed within and/or configured as part of the MMPO TOOL controller. Further detail regarding implementations of MMPO TOOL controller operations, components, and databases is provided below.

In the implementation illustrated in FIG. 1B, the MMPO TOOL controller 160 may be configured to couple to external entities via a maintenance interface 154, a power interface 156, a user interface 158 and a network interface 155. The user interface 158 may, for example, receive and configure reminders sent to/from the MMPO TOOL, secured user account information, user submitted configuration data, user specified media objective data, user provided client data, and/or the like. In various implementations, the network interface 155 may, be configured for receipt and/or transmission of data to an external and/or network database, e.g. a third party data source providing macro economic data. In one embodiment, the maintenance interface 154 may, for example, configure regular inspection and repairs, receive system upgrade data, report system behaviors, and/or the like. In one embodiment, the power interface 156 may, for example, connect the MMPO TOOL system to an external power source.

In one implementation, the MMPO TOOL controller 160 may further be coupled to a plurality of components configured to implement MMPO TOOL functionality and/or services. The plurality of components may, in one embodiment, be configurable to instantiate an online or offline application for media planning forecasting. In one embodiment, the MMPO TOOL may comprise components such as, but not limited to a Macro Economic Data Processing Component 170, a Regression Component 174, an Authentication Component 175, a Forecast Data Generator Componnet 176, a Logging Component 178, and/or the like.

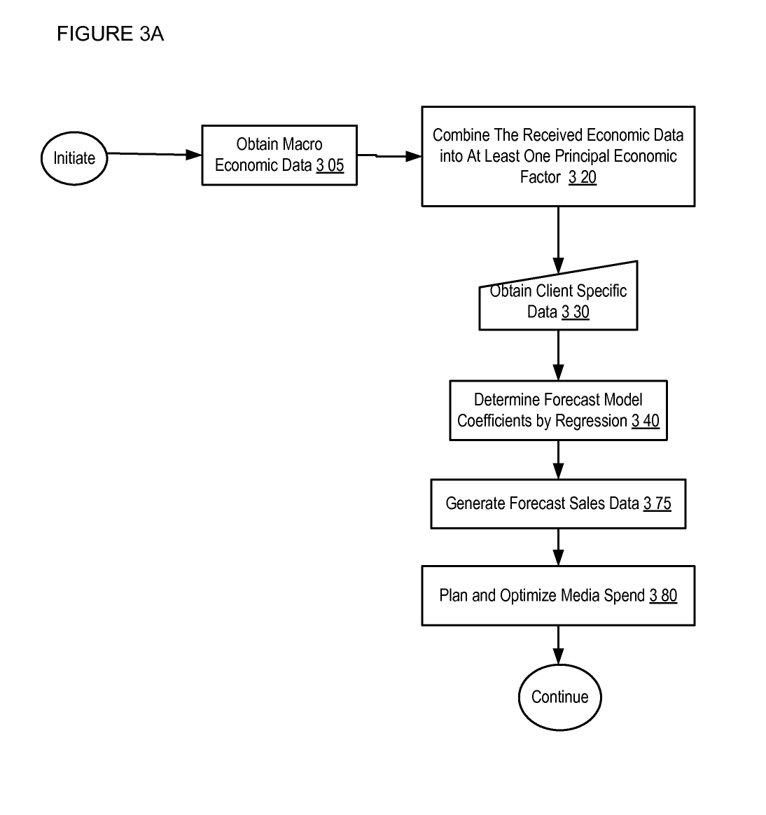

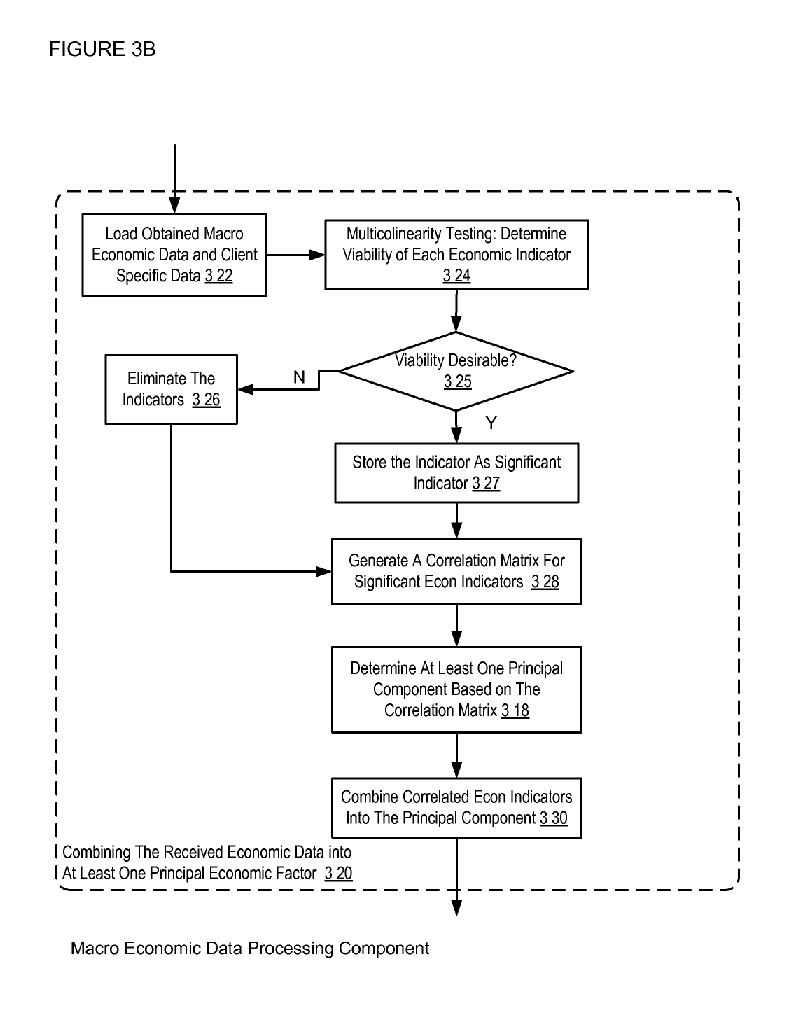

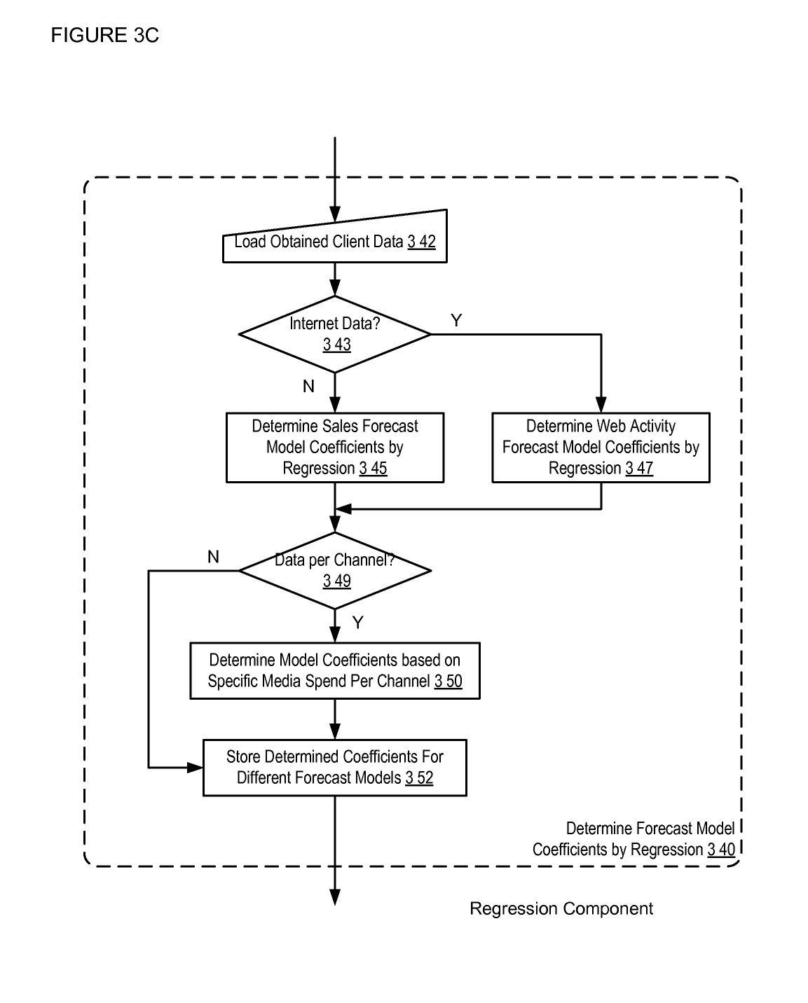

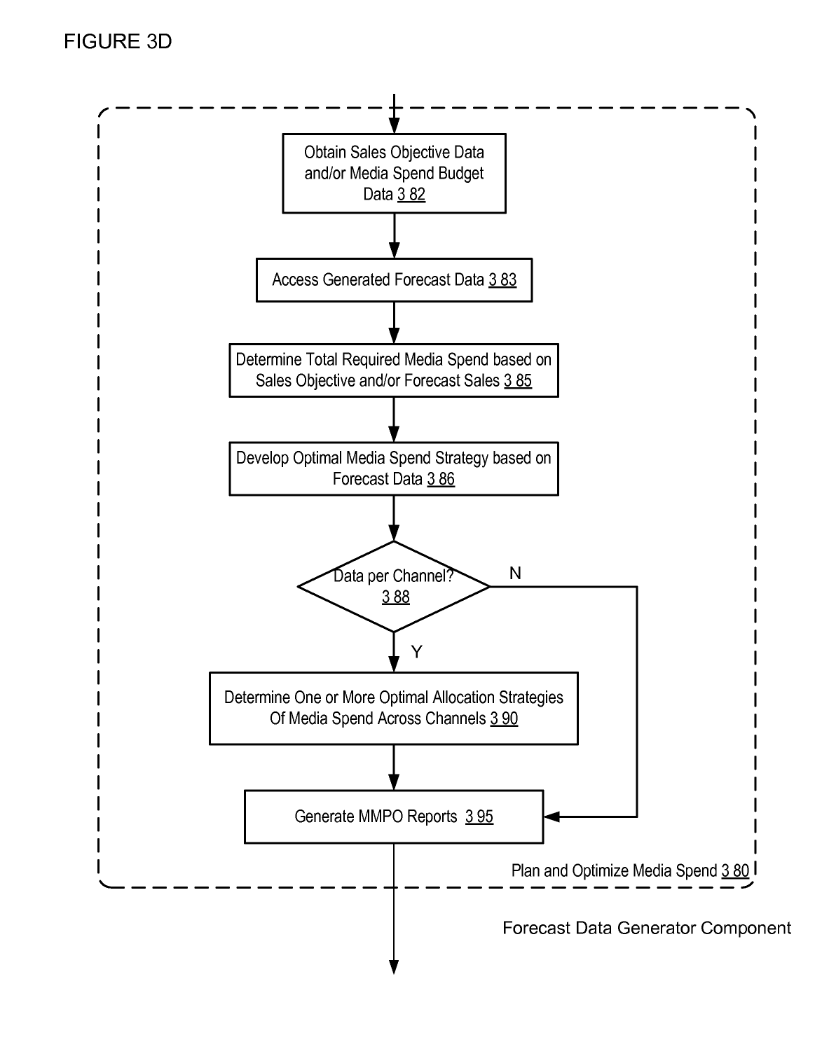

In one embodiment, the Macro Economic Data Processing Component 170 may obtain macro economic data from third party data sources, and distill the various economic factors into one principal economic factor. For example, in one implementation, the Macro Economic Data Processing Component 170 may scrub the received raw data via multicolinearity testing to eliminate unviable indicators, and combine the remaining viable indicator into one factor based on their correlations, as further illustrated in FIGS. 2 and 3B.

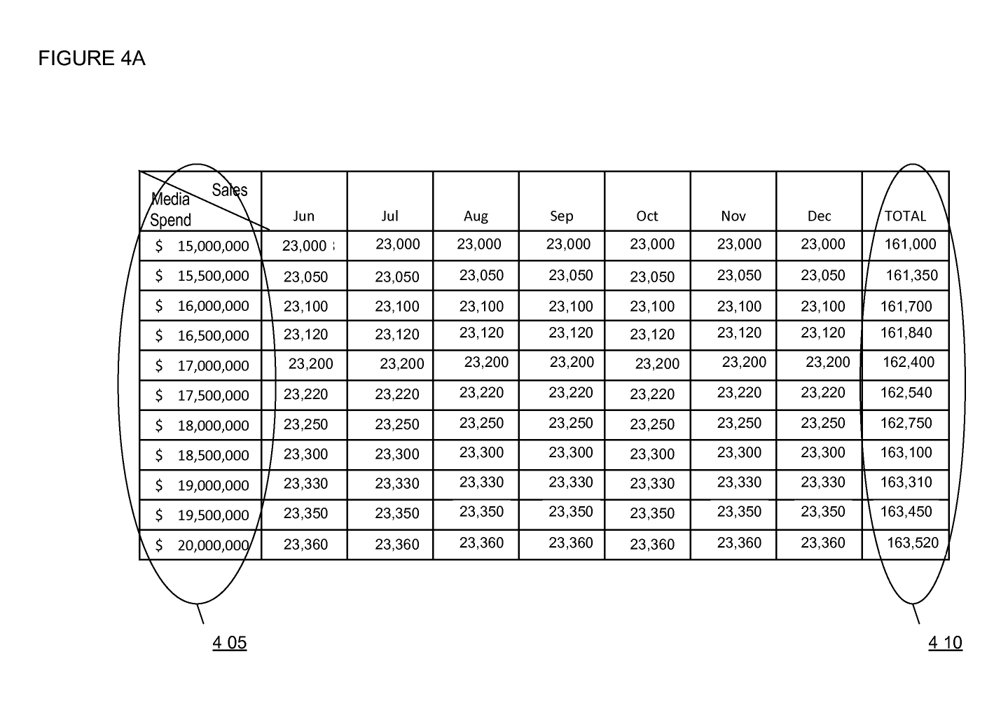

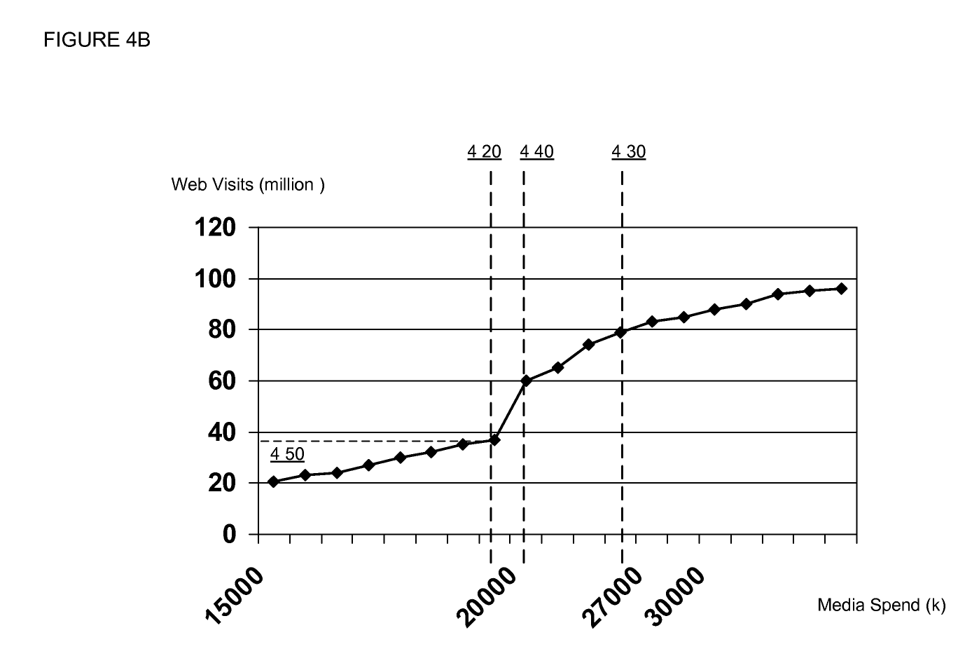

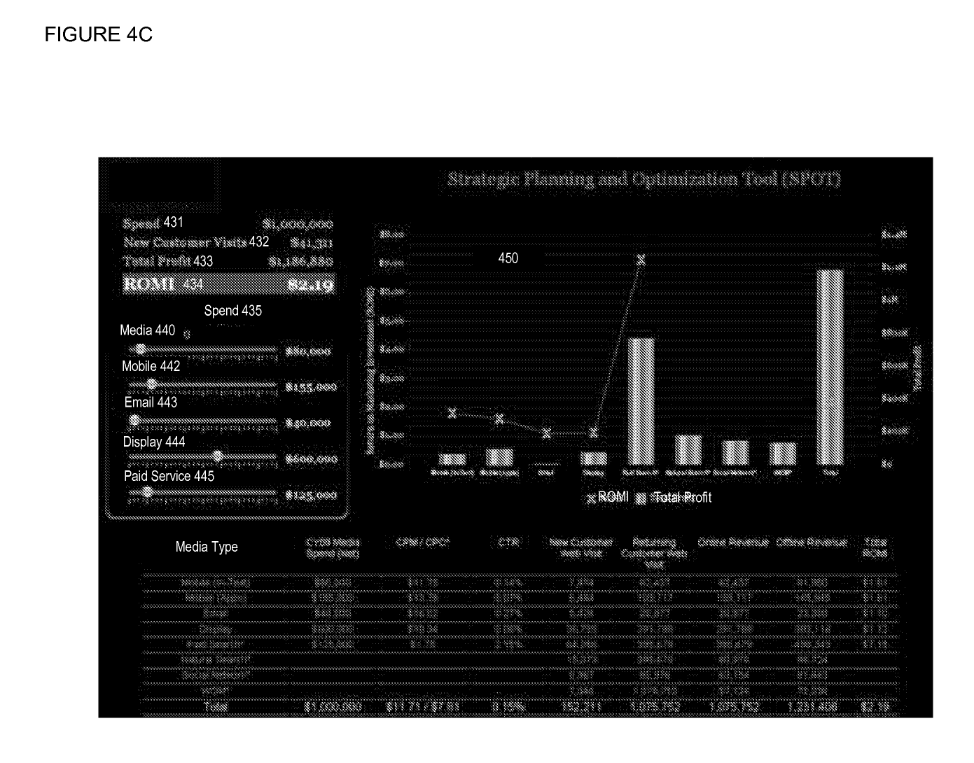

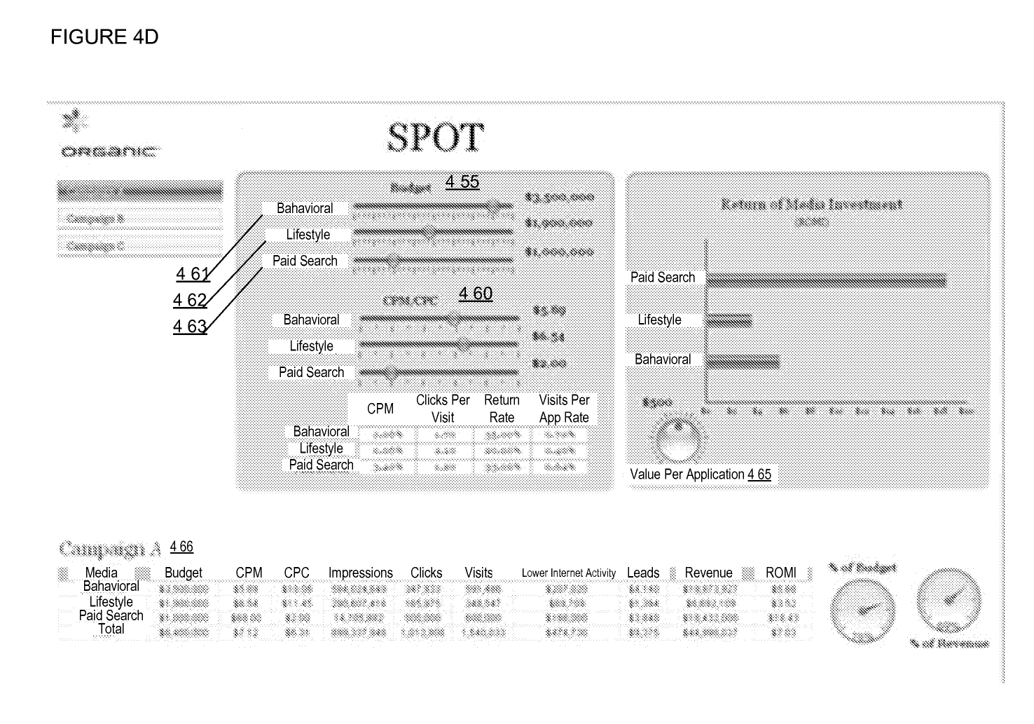

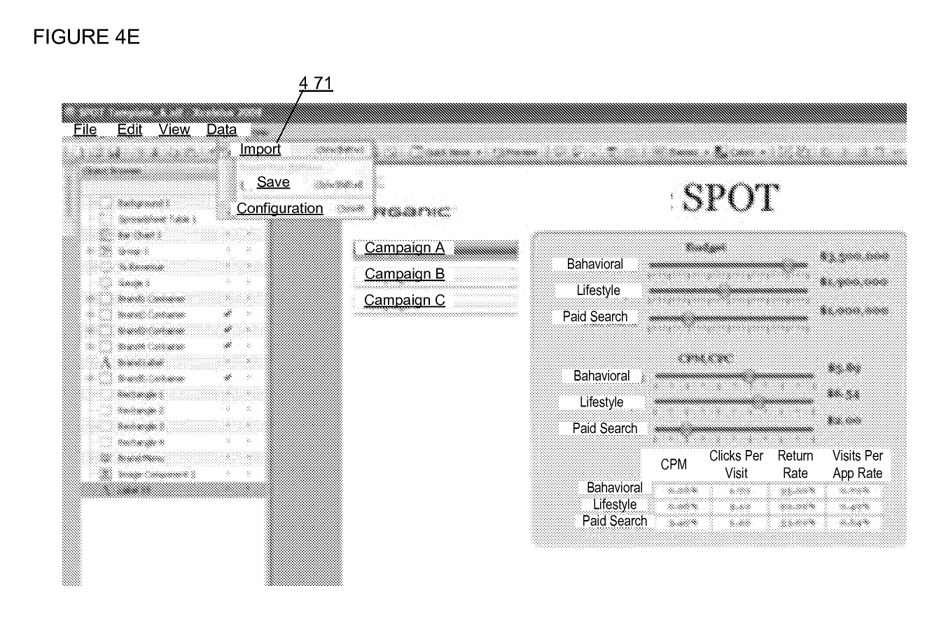

In one embodiment, the Regression Component 174 may analyze client historical media performance data to devise a media spend vs. return/profit forecast model, as further illustrated in FIGS. 2 and 3C. In one embodiment, the Forecast Data Generator Component 176 may generate forecast data based on the established forecast model from Regression Component 174, as further illustrated in FIGS. 3C and 4A-C. For example, in one implementation, the Forecast Data Generator 176 may obtain user-specified media spend data, and output the forecast return and profit. In another implementation, 176 may provide a suggested media spend plan based on client desired sales/profit objective. In one implementation, the Forecast Data Generator Component 176 may generate reports with charts/graphs such as, but not limited to pie charts, bar charts, statistical graphs, and/or the like.

In one embodiment, the Authentication component 175 may be configured to receive secured account information from a user via a user interface of the MMPO TOOL, and grant the user or group access to the MMPO TOOL if provided secured login information is correct. In one embodiment, users may configure group access to a plurality of stored forecast data. In one embodiment, the Authentication component 175 may communicate with the users database to retrieve user profile information. The Logging component 178 may log activities of the application and write the log information in a file and store the log file.

In one implementation, the MMPO TOOL controller 160 may further be coupled to one or more databases configured to store and/or maintain MMPO TOOL data. A user database 185 may contain information pertaining to account information, contact information, profile information, identities of hardware devices, Customer Premise Equipments (CPEs), and/or the like associated with users, reminder preferences, reminder configurations, system settings, and/or the like. A hardware database 184 may contain information pertaining to hardware devices with which the MMPO TOOL system may communicate, such as but not limited to Email servers, user telephony devices, CPEs, gateways, routers, user terminals, and/or the like. The hardware database 228 may specify transmission protocols, data formats, and/or the like suitable for communicating with hardware devices employed by any of a variety of MMPO TOOL affiliated entities. A Client database 183 may contain data pertaining to client projects, such as, but not limited to client historical media spend data, client information, client objectives, client project model, and/or the like. In one implementation, the Economic database 182 may contain data pertaining to the received macro economic data.

The MMPO TOOL database may be implemented using various standard data-structures, such as an array, hash, (linked) list, struct, structured text file (e.g., XML), table, and/or the like.

FIG. 2 shows a diagram of data flows for implementing the MMPO TOOL in one embodiment of the MMPO TOOL. The MMPO TOOL server 120 may obtain macro economic data 205 from a third party data source. For example, For example, in one embodiment, the economic indicators may include, but not limited to the following factors:
Gas Prices: Weekly U.S. Regular Conventional Retail Gasoline Prices (Cents per Gallon) as reported by the Energy Information Administration
New Housing Starts: New Privately Owned Housing Units Started in the United States as reported by the U.S. Census Bureau)
Unemployment Rate: Civilian Unemployment Rate as reported by U.S. Department of Labor: Bureau of Labor Statistics)
Prime Interest Rate: Bank Prime Loan Rate as reported by the Board of Governors of the Federal Reserve System. The Bank Prime Loan Rate is a reference interest rate used by banks in calculating variable rate short term loans.
Mortgage Rate (30 yr fixed): 30-Year Conventional Mortgage Rate as reported by the Board of Governors of the Federal Reserve System
S&P 500: the S&P 500 is an index published by Standard & Poor's of the prices of 500 large cap stocks actively in the United States.
Consumer Sentiment: consumer sentiment index as analyzed and provided by a third party data service entity, which may include a consumer confidence index focused on how consumers view prospects for their own financial situation, how they view prospects for the general economy over the near term, and their view of prospects for the economy over the long term.
M2: M2 Money Stock as reported by the Board of Governors of the Federal Reserve System. The M2 is a measure of the total amount of money available in an economy at a particular point in time.
PMI: PMI Composite Index as reported by the Institute for Supply Management. The PMI is a composite index that is based on five indicators: new orders, inventory levels, production, supplier deliveries, and the employment environment.

In one implementation, the MMPO TOOL may also incorporate indicators such as total consumer credit outstanding, personal income, personal savings, and/or the like. In an alternative embodiment, macro economic data may be uploaded by a user. For example, a user may obtain economic data report file from a paid data service, and upload the data file to the MMPO TOOL via a user interface, e.g. as illustrated in one implementation in FIG. 4E.

In one embodiment, the MMPO TOOL may determine the viability of each economic indicator. In one implementation, the MMPO TOOL may determine the correlation between an economic factor and the sales data, and may eliminate factors with low correlation with the sales data. For example, in a scenario when there is a sudden drop in gas prices, there may not be a clear relationship between gas prices and vehicle sales. In that case, gas prices may not be incorporated into the sales forecast model. In an alternative implementation, the MMPO TOOL may run regression analysis to determine inter-correlations between economic factors and combine highly related factors. For example, consumer credit outstanding, personal income, and personal savings may be combined into one economic indicator representing the consumer finance index.

In one embodiment, the MMPO TOOL server may automatically access and download published economic data from the Internet based on the stored links pointing to a website, an online database, and/or the like, and update the MMPO database accordingly. For example, in one implementation, the MMPO TOOL server may be configured to download and update data files in the MMPO database regarding gas prices from “eia retail gasoline historic prices” at http://www.eia.doe.gov/oil_gas/petroleum/data_publications/wrgp/mogas_history.html. In another embodiment, the MMPO TOOL server may receive economic data files submitted by a user. In another embodiment, the MMPO TOOL server may retrieve stored macro economic data from the system database. In one implementation, the MMPO TOOL server may obtain data files in desirable data format, e.g. .txt, .xls, etc. In another implementation, the MMPO TOOL server may read and extract data if the obtained data files are Adobe pdf files.

In an alternative implementation, the MMPO TOOL may receive data files from data service entities, which may collect and aggregate analytic data with regard to economic and market indicators into a spreadsheet. For example, a spreadsheet comprising consumer sentiment indicators may take a form similar to:

| | |
|---|---|
| Series ID: | UMCSENT |
| Source: | Survey Research Center: University of XYZ |
| Release: | Surveys of Consumers |
| Seasonal | Not Seasonally Adjusted |
| Adjustment: | |
| Frequency: | Monthly |
| Units: | Index 1st Quarter 1966 = 100 |
| Date Range: | 1978 Jan. 01 to 2009 Mar. 01 |
| Last Updated: | 2009 Apr. 17 10:02 AM CDT |
| Notes: | The most recent value is not shown due to |
| | an agreement with the source. To obtain |
| | historical data prior to January 1978, |
| | please see FRED data series UMCSENT1. |
| | Copyright, 2008, Survey Research Center, |
| | University of XYZ. Reprinted with permission. |

| DATE | VALUE |
|---|---|
| 1978 Jan. 01 | 83.7 |
| 1978 Feb. 01 | 84.3 |
| 1978 Mar. 01 | 78.8 |
| 1978 Apr. 01 | 81.6 |
| 1978 May 01 | 82.9 |
| . . . | . . . |
| 2008 Sep. 01 | 70.3 |
| 2008 Oct. 01 | 57.6 |
| 2008 Nov. 01 | 55.3 |
| 2008 Dec. 01 | 60.1 |
| 2009 Jan. 01 | 61.2 |
| 2009 Feb. 01 | 56.3 |
| 2009 Mar. 01 | 57.3 |

In one embodiment, the macro economic data may be submitted to and processed at the regression engine 210 of the MMPO TOOL. A principal economic factor 215 may then be generated by the regression engine 210, and be passed on to the regression engine 210 but for a different regression purpose, as will be illustrated in one implementation in FIG. 3A-3C. In one embodiment, the principal economic factor may be used to develop general economic forecast based on predicted segment retail units.

The MMPO TOOL server 120 may also obtain client data from the user 110, such as media spend data 211, sales data 212, incentive data 213, Internet activity data 214, etc. For example, the media spend data 211 may include total media spend, media spend by type (TV, print, online, etc), media spend by execution level (Digital Advertising Agency (DAA), National spend, etc), and/or the like. The Internet activity data 214 may include number of total web visits, number of leads, number of search inventory leads, and/or the like.

For example, in one implementation, the MMPO TOOL may obtain a spreadsheet file from the client indicating the media spend data. The spreadsheet may take a form similar to:

| | | | | Target | |
|---|---|---|---|---|---|
| | | | | Rating | Gross |
| Client | Location | Media Type | Period | Points | Costs |
| XYZ Marketing | Bakersfield, CA | Network Cable TV | Mar. 16, 2009 | 18 | 931.00 |
| XYZ Marketing | Bakersfield, CA | Network Cable TV | Mar. 23, 2009 | 18 | 936.00 |
| XYZ Marketing | Bakersfield, CA | Spot TV | Feb. 16, 2009 | 67 | 935.00 |
| XYZ Marketing | Bakersfield, CA | Spot TV | Feb. 23, 2009 | 67 | 935.00 |
| XYZ Marketing | Bakersfield, CA | Spot TV | Mar. 2, 2009 | 67 | 935.00 |
| XYZ Marketing | Chico, CA | Network Cable TV | Mar. 16, 2009 | 20 | 931.00 |
| XYZ Marketing | Chico, CA | Network Cable TV | Mar. 23, 2009 | 20 | 935.00 |
| XYZ Marketing | Chico, CA | Spot TV | Feb. 16, 2009 | 67 | 945.00 |
| XYZ Marketing | Chico, CA | Spot TV | Feb. 23, 2009 | 67 | 935.00 |
| . . . | . . . | . . . | . . . | . . . | . . . |
| XYZ Marketing | Eureka, CA | Network Cable TV | Mar. 16, 2009 | 21 | 858.23 |
| XYZ Marketing | Eureka, CA | Network Cable TV | Mar. 23, 2009 | 21 | 858.58 |
| XYZ Marketing | Eureka, CA | Spot TV | Feb. 16, 2009 | 67 | 896.02 |
| XYZ Marketing | Eureka, CA | Spot TV | Feb. 23, 2009 | 67 | 896.02 |
| XYZ Marketing | Eureka, CA | Spot TV | Mar. 2, 2009 | 67 | 896.02 |
| XYZ Marketing | Fresno, CA | Network Cable TV | Mar. 16, 2009 | 16 | 846.12 |
| XYZ Marketing | Fresno, CA | Network Cable TV | Mar. 23, 2009 | 16 | 843.00 |
| XYZ Marketing | Fresno, CA | Spot TV | Feb. 16, 2009 | 67 | 855.00 |
| XYZ Marketing | Fresno, CA | Spot TV | Feb. 23, 2009 | 67 | 869.32 |
| XYZ Marketing | Fresno, CA | Spot TV | Mar. 2, 2009 | 67 | 869.32 |
| XYZ Marketing | Los Angeles, CA | Network Cable TV - | Mar. 16, 2009 | 26 | 46354.00 |
| | | DAA | | | |
| XYZ Marketing | Los Angeles, CA | Network Cable TV - | Mar. 23, 2009 | 26 | 46332.00 |
| | | DAA | | | |
| XYZ Marketing | Los Angeles, CA | Spot Radio | Jan. 26, 2009 | 58 | 46335.00 |

In alternative implementations, the client data files may be in a variety of formats, such as txt, pdf, XML files, and/or the like.

In one embodiment, the client specific data 211-214 and the principal economic factor 215 may be processed at the regression engine 210 and regression coefficients 222 may then be generated.

The generated regression coefficients 222, together with user submitted sales objective data 220 and historic campaign data 225, may be processed by a media planning engine 230 of the MMPO TOOL server. The MMPO TOOL server may then generate and display an MMPO report to the user. For example, the MMPO report may include sales forecast data, web visits forecast data, the minimum media spend to meet sales objective, analysis of the forecast data, and/or the like.

FIG. 3A is an overview of logic flow diagram illustrating aspects of MMPO TOOL operation. In FIG. 3A, after the system is initiated, the MMPO TOOL may obtain macro economic data 305. Based on the obtained macro economic data and client sales data, the MMPO TOOL may determine the significant economic indicators to sales and combine the economic indicators into at least one principal economic factor 320, as will be illustrated in one implementation in FIG. 3B.

The MMPO TOOL may further obtain a variety of client specific data 330, as illustrated in one implementation of FIG. 2. The MMPO TOOL may determine forecast structure coefficients by regression 340 based on the obtained client specific data and the determined economic factor(s), as will be illustrated in FIG. 3C. For example, in one embodiment, a sales forecast structure may adopt a double logarithmic regression formula, similar to the following:

$$Sales = {β}_{0} + {β}_{1} \times {X}_{1} + {β}_{2} \times {X}_{2} + \frac{k}{( 1 + {e}^{- b + {X}_{3}} )} + ɛ , \qquad ( 1 )$$

wherein β₀ denotes an intercept of the regression structure; X₁ denotes media spend, and β₁ denotes the coefficient of media spend; X₂ denotes an economic factor, and β₂ denotes the coefficient of the economic factor; k denotes the carrying capacity of the incentive/promotion plan of the client, b denotes a growth rate of sales price and X₃ denotes the incentive/promotion level; ε denotes a regression tail. Thus in this particular example, the MMPO TOOL may determine the regression coefficients β₀, β₁ and β₂ at 340. In one embodiment, if Internet activity data is available, the MMPO TOOL may forecast Internet activity (e.g. web visits) based on a similar regression structure to the above formula, e.g.

$$WebVisits = {β}_{0} + {β}_{1} \times {X}_{1} + {β}_{2} \times {X}_{2} + \frac{k}{( 1 + {e}^{- b + {X}_{3}} )} + ɛ , \qquad ( 2 )$$

and determine the regression coefficients accordingly.

In one implementation, if separate media spend data per media type and/or channel, e.g. media investment in a specific TV channel, a magazine, a radio channel, a commercial website, etc, is available, the MMPO TOOL may also implement the regression structure and calculate coefficients for forecast structures based on media spend of the specific media type and/or channel. For example, in one implementation, regression coefficients may be calculated by replacing the media spend data X₁ in equations (1) and (2) with media spend of a specific media type and/or channel. For another example, the media spend data X₁ in equations (1) and (2) may be media spend by media execution level (DAA/national), media spend classified by two main media buckets (offline/online), and/or the like, to determine the relative impact of each media stream.

In another embodiment, the MMPO TOOL may also automatically retrieve weblogs from the client website, and/or generate queries through twitter and other social media alike. In another implementation, the MMPO TOOL may obtain data related to weblogs and twitter inquiries from a third party. The MMPO TOOL may aggregate the generated data from social media into the regression engine as a regressor.

In one embodiment, the MMPO TOOL may generate forecast sales data 375 based on the determined forecast structure coefficients. For example, in one implementation, the MMPO TOOL may choose a range of media spend and time period, wherein the range of media spend and time period may be submitted by a user. The MMPO TOOL may then calculate the forecast sales data based on the input range of media spend during the chosen time period. In one implementation, the forecast structure may employ Seasonally Adjusted Annual Rate (SAAR) to adjust the economic factor. For example, in one implementation, if the sales of a year (from January to December) is forecasted, and an SAAR per month is provided, then the forecasted sales of every month may be calculated based on equation (1) by multiplying the economic factor X₂ with the monthly SAAR. In one implementation, forecast data may be based on media spend of a specific media type and/or channel if the specific media spend data is available.

FIG. 3B shows a logic flow diagram illustrating aspects of combining received macro economic data into at least one economic factor in one embodiment of the MMPO TOOL; in one embodiment, taking the form of a Macro Economic Data Processing component 170 of the MMPO TOOL The MMPO TOOL may load obtained macro economic data and client specific data 322, and determine viability of each economic indicator through multicolinearity testing 324. For example, in one implementation, multicollinearity diagnostic statistics may be implemented in SAS under “PROC REG” with options “VIF TOL” (a segment of sample SAS code for linear regression is provided in one implementation as of FIG. 3C). In one implementation, the viability of each economic indicator may be defined as the tolerance and/or variance inflation factor (VIF) of the indicator, wherein the indicator may be eliminated if its tolerance (VIF resp.) is less (higher resp.) than a predetermined level, e.g. tolerance<0.1 and/or VIF>10. In one embodiment, if the calculated viability is desirable 325, the MMPO TOOL may store the economic indicator as a significant economic indicator 327. Otherwise, the indicator may be eliminated 326. For example, for vehicle sales, 9 economic indicators are loaded at 322 as macro economic data, including gas prices, new housing starts, unemployment rate, civilian unemployment rate, prime interest rate, bank prime loan rate, the bank prime loan rate, mortgage rate, 30-year conventional mortgage rate, S&P 500, consumer sentiment, M2 Money Stock, and PMI Composite Index. At 324-327, the MMPO TOOL may determine that all indicators have favorable viability and are significant indicators except gas prices. For instance, the macro economy at the instant time may be experiencing a sudden drop in gas prices, and thus gas prices may no longer reflect trends in vehicle sales.

In one embodiment, the MMPO TOOL may generate a correlation matrix for the remaining significant economic indicators 328, and then determine at least one principal component based on the correlation matrix 318. For example, in one implementation, the principal component may be determined by calculating the eigenvalues of the correlation matrix and the principal component indicator may be determined as the one that corresponds to the greatest eigenvalue. The MMPO TOOL may then combine the significant economic indicators into the at least one principal component 330 based on the calculated correlation. For example, in one implementation, the principal factor analysis associated with 328 and 330 may be implemented by SAS in addition to many others. One non-limiting example of SAS code implementation may take a form similar to the following:

PROC FACTOR data = “C:\macro_econ” corr scree residuals method =
principal;
VAR indicator1 indicator2 indicator3 indicator4 indicator5 indicator6;
RUN;

FIG. 3C shows a logic diagram illustrating aspects of determining forecast structure coefficients by regression in one embodiment of the MMPO TOOL; in one embodiment, taking the form of a Regression Component 174 of the MMPO TOOL. In one embodiment, the MMPO TOOL may load obtained client data 342, including media spend data, sales data, incentive/promotion data, Internet activity data, and/or the like. The MMPO TOOL may then determine whether Internet activity data is available 343. if Internet activity data is not available, the MMPO TOOL may determine sales forecast structure coefficients by regression 345. For example, in one implementation, the SAS may be used in addition to many other implementations. One non-limiting example of SAS code for obtaining regression coefficients of equation (1) may be similar to the following form:

PROC REG DATA=VehecleSales;
MODEL sales=media_spend econ_factor incentive_data / p clim;
RUN;

In one implementation, if Internet activity data is available at 343, the MMPO TOOL may determine web activity forecast structure coefficients by regression 347 according to equation (2) with similar SAS analysis to those discussed above.

In one implementation, the MMPO TOOL may determine whether media spend data classified by a specific media type and/or channel is available 349. If such data is available, the MMPO TOOL may determine coefficients for structures classified by different media types, by different TV channels 350, etc, using similar SAS analysis to those discussed above. The MMPO TOOL may then store the determined coefficients for different forecast structures 352.
For example, in one implementation, SAS may be used for determining forecast model coefficients by regression formula (1) in addition to many other implementations. One non-limiting example SAS implementation may take a form similar to the following:

/*Input Dataset*/
%let modeldata=trdata.tdata;
/*Output Location*/
%let out=C:\Documents and Settings\jprantne\My Documents\My Dropbox\TOMM ROMI
Programs\Output;
/*Linear Variables For Model*/
%let linear=Factor1*online;
/*Number of Fixed Variables*/
%let numlinearvar=2;
/*S-Curve Variables For Model*/
%let scurve=alltv*print;
/*Number of S Curve Variables*/
%let numscurvevar=2;
/*Success Variable*/
%let success=delivered;
/****Defines Variables****/
%let var=b*c*d*e*f*g*h*i*j*k*l*m*n*o*p*q*r*s*t*u*v*w*x*y*z;
%let
cc=aa*bb*cc*dd*ee*ff*gg*hh*ii*jj*kk*ll*mm*nn*oo*pp*qq*rr*ss*tt*uu*vv*ww*xx*yy*z
z;
%let
d=aaa*bbb*ccc*ddd*eee*fff*ggg*hhh*iii*jjj*kkk*lll*mmm*nnn*ooo*ppp*qqq*rrr*sss*t
tt*uuu*vvv*www*xx*yyy*zzz;
/*%let totvar=0;*/
%do i=1 %to &numlinearvar;

%let linear&i=%scan(&linear,&i,“*”);

/* %let totvar=%eval(%eval(&totvar)+1);*/

%let lcoef&i=%scan(&var,&i,“*”);

/* %let lin&i=(%eval(&totvar);*/
%end;
%do i=1 %to &numscurvevar;

%let scurve&i=%scan(&scurve,&i,“*”);
%let cc&i=%scan(&cc,&i,“*”);

/* %let totvar=%eval(%eval(&totvar)+1);*/

%let scoef&i=%scan(&d,&i,“*”);

/* %let s&i=(%eval(&totvar);*/
%end;
title ‘TOMM’;
proc nlin data= &modeldata ;
parms
a=−10000
%do i=1 %to &numlinearvar; &&lcoef&i = 0.00003 %end;
%do i=1 %to &numscurvevar; &&cc&i = 500000 &&scoef&i = 0.00003 %end;
;

model delivered = a %do i=1 %to &numlinearvar; + &&linear&i * &&lcoef&i %end;

%do i=1 %to &numscurvevar; + &&cc&i /(1+exp(−&&scoef&i*(&&scurve&i))) %end; ;
/*output out=jpinout p=predv r=rv;*/
run;

In another example, a non-limiting example of SAS implementation for determining webvisit forecast model coefficients based on regression formula (2) may take a form similar to the following:

/*Input Dataset*/
%let modeldata=trdata.rdata;
/*Output Location*/
%let out=C:\Documents and Settings\jprantne\My Documents\My Dropbox\TOMM ROMI
Programs\Output;
/*Fixed Variables For Model*/
%let
fixed=Factor1*lag5print2*alltv6*lag4online*llag4dealerlocatesd2*lag1hhleads*lla
g3inventoryd4;
/*Number of Fixed Variables*/
%let numfixedvar=7;
/*Raw Individual Variables to Which Volume Will Be Attributed*/
%let rindividual=dealerlocates*hhleads*inventory;
/*Number of Raw Individual Variables*/
%let rnumindvar=3;
/*Random Variables (Other than Intercept From Proc Mixed)*/
%let rand=;
/*Number of Random Variables*/
%let numrandvar=0;
/*Logged Success Variable*/
%let lsuccess=ldelivered;
/*Level at Which Intercept is Random*/
%let randlevel=npnum;
/****Defines Variables****/
%do i=1 %to &numfixedvar;

%let fixed&i=%scan(&fixed,&i,“*”);

%end;
%do i=1 %to &rnumindvar;

%let rindividual&i=%scan(&rindividual,&i,“*”);

%end;
%do i=1 %to &numrandvar;

%let rand&i=%scan(&rand,&i,“*”);

%end;
/*********Model**************/
title ‘ROMI Model’;
proc mixed data= &modeldata scoring=8 covtest noclprint noitprint;

class &randlevel wk;
model &lsuccess= %do i=1 %to &numfixedvar; &&fixed&i %end;

/ddfm=betwithin s outp=trdata.pred(keep=&randlevel wk pred resid);

random int %do i=1 %to &numrandvar; &&rand&i %end;/ s subject = &randlevel;
repeated wk / type=ar(1) subject=&randlevel;
ods output solutionf=trdata.solutionf ;
ods output solutionr=trdata.solutionr ;
ods output covparms=trdata.covparms ;

run;
proc sort data=&modeldata;

by &randlevel;

run;
proc means data=&modeldata noprint;

by &randlevel;
var %do i=1 %to &rnumindvar; &&rindividual&i %end;
;
output out = trdata.raw sum=;

run;

FIG. 3D shows a logic diagram illustrating aspects of planning and optimizing media spend in one embodiment of the MMPO TOOL; in one embodiment, taking the form of the Forecast Data Generator Component 176. In one embodiment, the MMPO TOOL may obtain sales objective data and/or media spend budget data 382 submitted by a user. For example, the sales objective data may include but not limited to, a total sales number over a fiscal year, and/or the like. In one implementation, the MMPO TOOL may calculate a brand level per new unit retail number for the sales objective.

In one embodiment, the MMPO TOOL may then access generated forecast data 383 and determine a total required media spend based on the received sales objective, or forecast sales based on the media spend budget 385. In one embodiment, the MMPO TOOL may be used to develop at least two types of sales and web visits forecasts: a forecast of sales/visits based on a planned media spend and a forecast of the media spend required based on a sales/visits target. The comparison between these two forecasts may illustrate the gap between what is planned and what is desired.

For example, in one implementation, FIG. 4A shows an example of sales forecast data of a vehicle manufacturer with media spend ranging from $15,000,000 to $20,000,000 through June to December. If the MMPO TOOL receives a sales objective 163,000 in total for the period from June to December, the MMPO TOOL may generate a query looking for the “TOTAL” 410 sales greater than or equal to 163,000, and a total required media spend of $18,500,000 may then be returned. In another implementation, if the client provides a media spend budget at $18,000,000, then the MMPO TOOL may generate forecast data based on the media spend via the sales forecast structure and/or the web visits structure.

In one embodiment, the MMPO TOOL may develop optimal media spend strategy based on the forecast data and sales objective 386. For example, in one implementation, FIG. 4B shows an example of web visits forecast curve. In one implementation, the MMPO TOOL may calculate the slope of the curve, wherein the slope may be defined as a Return on Media Investment (ROMI) value. The MMPO TOOL may then suggest the media spend range with the most desirable ROMI value, e.g. $200,000,000 (420) to $270,000,000 (430). For another example, in one implementation, if the MMPO TOOL receives a media budget at $220,000,000 (440) and an objective of 38 million web visits (450), the MMPO TOOL may calculate that a minimum media spend to reach the objective is $200,000,000 and return a media spend value between $200,000,000 and $220,000,000 with the highest ROMI value.

In another implementation, historic campaign performance data may also be incorporated into the media spend strategy development. For example, the MMPO TOOL may analyze historic campaign data such as campaign website click through rates, campaign website conversion rates, expected optimization gains, and/or the like.

In one embodiment, the MMPO TOOL may further determine whether forecast data separated by TV channel is available 388. If forecast data is available per TV channel, the MMPO TOOL may determine one or more allocation strategy of media spend across different channels 390. For example, in one implementation, the MMPO TOOL may form a query looking for the maximal sales objective among a set of feasible allocations of media spend across different channels within the media spend budget.

In one embodiment, the MMPO TOOL may generate an MMPO report to the client 395, wherein the MMPO report may include, but not limited to sales forecast data spreadsheets and plots, web visits forecast data spreadsheets and plots, web activity value charts, and/or the like.

In one implementation, FIG. 4C provides an example screenshot of the MMPO TOOL illustrating embodiments of sales forecasts and strategic planning and optimization. In one embodiment, the MMPO TOOL may provide a summary of total media spend 431, the incurred new customer visits 432, the incurred total profit 433, and the calculated ROMI value 434. For example, as shown in FIG. 4C, if the total spend is 1 million dollars for a period of time, the forecasted new customer visits may be worth $41,311, associated with a total profit of $1,186,880. The ROMI value for this example is $2.19. In one implementation, the relationship between ROMI values and total profit is also graphically illustrated via the plot 450.

In one implementation, the media spend may be entered by a user via a user interface. For example, as illustrated in FIG. 4C, the MMPO TOOL may provide sliding buttons for the user to select marketing spend 435 via media 440, mobile 442, email 443, display 444, paid service 445, and/or the like. In one implementation, a user may enter a total spend amount 431, and the MMPO TOOL may provide suggested allocations of spend among different categories 440-445 to optimize the media return. In an alternative implementation, the user may change allocated values of media spend in one or more categories (e.g., by sliding the buttons 440-445). In that case, the MMPO TOOL may re-calculate the spend 431, and re-run the forecast model to estimate the incurred new customer visits 432, the total profit 433 and the associated ROMI value 434.

In a further implementation, the MMPO TOOL may allow a user to input a desired marketing outcome, e.g., a desired customer visit number, a desired total profit, or a desired ROMI value via a user interface, which in turn analyze the forecast model to provide suggested media spend values 440-445. FIG. 4E provides an example screenshot illustrating the MMPO TOOL in one implementation. For example, a user may enter desired campaign budget 455 information by changing budget values in different advertising categories, such as behavioral 461, lifestyle 462, paid search 463 and/or the like. In another implementation, a user may input desired Cost Per Impression or Cost Per Click (CPM/CPC) values 460. The MMPO TOOL may provide a summary 466 illustrating media spend and the outcomes, such as CPM/CPC, impressions, clicks, visits, lower Internet activity, leads, revenue, ROMI, and/or the like.

In a further implementation, a user may specify a desired outcome, as well as a tentative media spend for one or more of the categories. For example, a user may specify a desired ROMI value 434 to be $2.20, a tentative spend of $43,000 in media 440 and a tentative spend of $20,000 in email 443. In another implementation, the user may modify the value per application 465 by turning the knob as shown in FIG. 4D. In that case, the MMPO TOOL may incorporate the user input parameters into the forecast model, and provide a set of suggested parameters including a total spend 431, as well as suggested spend in mobile, display and paid service in order to achieve the user-specified desired ROMI value under the user-specified constraints (spend in media and email).

In one implementation, if no spend solution is available under the user specified parameters, the MMPO TOOL may provide an error message “Infeasible Media Nanning.” For example, if the user has entered a total media spend of $0.00 and a desired ROMI value at $5.00, the MMPO TOOL may return the error message indicating bad input parameters. FIG. 4E provides an example screenshot of the MMPO TOOL illustrating an user interface in one implementation for a user to upload data files. For example, a user may select an “Import” 461 option under the menu option “Data” to upload a data file, e.g., a client data report with regard to historical media spend and return, etc.

### MMPO TOOL Controller

FIG. 5 illustrates inventive aspects of a MMPO TOOL controller 501 in a block diagram. In this embodiment, the MMPO TOOL controller 501 may serve to aggregate, process, store, search, serve, identify, instruct, generate, match, and/or facilitate interactions with a computer through network technologies, and/or other related data.

Typically, users, which may be people and/or other systems, may engage information technology systems (e.g., computers) to facilitate information processing. In turn, computers employ processors to process information; such processors 503 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the MMPO TOOL controller 501 may be connected to and/or communicate with entities such as, but not limited to: one or more users from user input devices 511; peripheral devices 512; an optional cryptographic processor device 528; and/or a communications network 513.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The MMPO TOOL controller 501 may be based on computer systems that may comprise, but are not limited to, components such as: a computer systemization 502 connected to memory 529.

### Computer Systemization

A computer systemization 502 may comprise a clock 530, central processing unit (“CPU(s)” and/or “processor(s)” (these terms are used interchangeable throughout the disclosure unless noted to the contrary)) 503, a memory 529 (e.g., a read only memory (ROM) 506, a random access memory (RAM) 505, etc.), and/or an interface bus 507, and most frequently, although not necessarily, are all interconnected and/or communicating through a system bus 504 on one or more (mother)board(s) 502 having conductive and/or otherwise transportive circuit pathways through which instructions (e.g., binary encoded signals) may travel to effect communications, operations, storage, etc. Optionally, the computer systemization may be connected to an internal power source 586. Optionally, a cryptographic processor 526 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the MMPO TOOL controller and beyond through various interfaces. Should processing requirements dictate a greater amount speed and/or capacity, distributed processors (e.g., Distributed MMPO TOOL), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the MMPO TOOL may be achieved by implementing a microcontroller such as CAST's R8051XC2 microcontroller; Intel's MCS 51 (i.e., 8051 microcontroller); and/or the like. Also, to implement certain features of the MMPO TOOL, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the MMPO TOOL component collection (distributed or otherwise) and/or features may be implemented via the microprocessor and/or via embedded components; e.g., via ASIC, coprocessor, DSP, FPGA, and/or the like. Alternately, some implementations of the MMPO TOOL may be implemented with embedded components that are configured and used to achieve a variety of features or signal processing.

Depending on the particular implementation, the embedded components may include software solutions, hardware solutions, and/or some combination of both hardware/software solutions. For example, MMPO TOOL features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the MMPO TOOL features. A hierarchy of programmable interconnects allow logic blocks to be interconnected as needed by the MMPO TOOL system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the MMPO TOOL may be developed on regular FPGAs and then migrated into a fixed version that more resembles ASIC implementations. Alternate or coordinating implementations may migrate MMPO TOOL controller features to a final ASIC instead of or in addition to FPGAs. Depending on the implementation all of the aforementioned embedded components and microprocessors may be considered the “CPU” and/or “processor” for the MMPO TOOL.

### Power Source

The power source 586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 586 is connected to at least one of the interconnected subsequent components of the MMPO TOOL thereby providing an electric current to all subsequent components. In one example, the power source 586 is connected to the system bus component 504. In an alternative embodiment, an outside power source 586 is provided through a connection across the I/O 508 interface. For example, a USB and/or IEEE 1394 connection carries both data and power across the connection and is therefore a suitable source of power.

### Interface Adapters

Interface bus(ses) 507 may accept, connect, and/or communicate to a number of interface adapters, conventionally although not necessarily in the form of adapter cards, such as but not limited to: input output interfaces (I/O) 508, storage interfaces 509, network interfaces 510, and/or the like. Optionally, cryptographic processor interfaces 527 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 509 may accept, communicate, and/or connect to a number of storage devices such as, but not limited to: storage devices 514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 510 may accept, communicate, and/or connect to a communications network 513. Through a communications network 513, the MMPO TOOL controller is accessible through remote clients 533b (e.g., computers with web browsers) by users 533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed MMPO TOOL), architectures may similarly be employed to pool, load balance, and/or otherwise increase the communicative bandwidth required by the MMPO TOOL controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 510 may be used to engage with various communications network types 513. For example, multiple network interfaces may be employed to allow for the communication over broadcast, multicast, and/or unicast networks.

Input Output interfaces (I/O) 508 may accept, communicate, and/or connect to user input devices 511, peripheral devices 512, cryptographic processor devices 528, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 511 may be card readers, dongles, finger print readers, gloves, graphics tablets, joysticks, keyboards, mouse (mice), remote controls, retina readers, trackballs, trackpads, and/or the like.

Peripheral devices 512 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the MMPO TOOL controller may be embodied as an embedded, dedicated, and/or monitor-less (i.e., headless) device, wherein access would be provided over a network interface connection.

Cryptographic units such as, but not limited to, microcontrollers, processors 526, interfaces 527, and/or devices 528 may be attached, and/or communicate with the MMPO TOOL controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 529. However, memory is a fungible technology and resource, thus, any number of memory embodiments may be employed in lieu of or in concert with one another. It is to be understood that the MMPO TOOL controller and/or a computer systemization may employ various forms of memory 529. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 529 will include ROM 506, RAM 505, and a storage device 514. A storage device 514 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 529 may contain a collection of program and/or database components and/or data such as, but not limited to: operating system component(s) 515 (operating system); information server component(s) 516 (information server); user interface component(s) 517 (user interface); Web browser component(s) 518 (Web browser); database(s) 519; mail server component(s) 521; mail client component(s) 522; cryptographic server component(s) 520(cryptographic server); the MMPO TOOL component(s) 535; and/or the like (i.e., collectively a component collection). These components may be stored and accessed from the storage devices and/or from storage devices accessible through an interface bus. Although non-conventional program components such as those in the component collection, typically, are stored in a local storage device 514, they may also be loaded and/or stored in memory such as: peripheral devices, RAM, remote storage facilities through a communications network, ROM, various forms of memory, and/or the like.

### Operating System

The operating system component 515 is an executable program component facilitating the operation of the MMPO TOOL controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems.

However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the MMPO TOOL controller to communicate with other entities through a communications network 513. Various communication protocols may be used by the MMPO TOOL controller as a subcarrier transport mechanism for interaction, such as, but not limited to: multicast, TCP/IP, UDP, unicast, and/or the like.

### Information Server

An information server component 516 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the MMPO TOOL controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the MMPO TOOL database 519, operating systems, other program components, user interfaces, Web browsers, and/or the like.

Access to the MMPO TOOL database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the MMPO TOOL. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the MMPO TOOL as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 517 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

20[0099] A Web browser component 518 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices.

A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the MMPO TOOL enabled nodes. The combined application may be nugatory on systems employing standard Web browsers.

### Mail Server

A mail server component 521 is a stored program component that is executed by a CPU 503. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the MMPO TOOL.

Access to the MMPO TOOL mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 522 is a stored program component that is executed by a CPU 503. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 520 is a stored program component that is executed by a CPU 503, cryptographic processor 526, cryptographic processor interface 527, cryptographic processor device 528, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the MMPO TOOL may encrypt all incoming and/or outgoing communications and may serve as node within a virtual private network (VPN) with a wider communications network.

The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the MMPO TOOL component to engage in secure transactions if so desired. The cryptographic component facilitates the secure accessing of resources on the MMPO TOOL and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The MMPO TOOL Database

The MMPO TOOL database component 519 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the MMPO TOOL database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the MMPO TOOL database is implemented as a data-structure, the use of the MMPO TOOL database 519 may be integrated into another component such as the MMPO TOOL component 535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 519 includes several tables 519a-d. A Users table 519a may include fields for user information 104 such as, but not limited to: user_ID, user_name, user_password, contact_info, hardware_ID, project_ID, project_history, user_evaluation and/or the like. A Hardware table 519b may include fields such as, but not limited to: hardware_ID, hardware_type, hardware_name, data_formatting_requirements, protocols, addressing_info, usage_history, hardware_requirements, user_ID, and/or the like. A economic data table 519c may include fields for macro economic data 101 such as, but not limited to: econ_ID, econ_description, econ_time, econ_value, econ_industry, econ_source, econ_project_ID, and/or the like. A client data table 519d may include fields of client data 102 and client forecast data 105 such as, but not limited to: client_ID, media_type (e.g. TV, print, Internet, etc), media_level (e.g. DAA, National, etc), media_channel (e.g. CNN, NBC, ABC, etc), media_spend, sales_time, sales_amount, web_visits_time, web_visits, web_activity, web_lead, client_model_coefficients 103, and/or the like. These tables may support and/or track multiple entity accounts on the MMPO TOOL controller.

In one embodiment, the MMPO TOOL database may interact with other database systems. For example, employing a distributed database system, queries and data access by search MMPO TOOL component may treat the combination of the MMPO TOOL database, an integrated data security layer database as a single database entity.

In one embodiment, user programs may contain various user interface primitives, which may serve to update the MMPO TOOL. Also, various accounts may require custom database tables depending upon the environments and the types of clients the MMPO TOOL may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 519a-d. The MMPO TOOL may be configured to keep track of various settings, inputs, and parameters via database controllers.

The MMPO TOOL database may communicate to and/or with other components in a component collection, including itself, and/or facilities of the like. Most frequently, the MMPO TOOL database communicates with the MMPO TOOL component, other program components, and/or the like. The database may contain, retain, and provide information regarding other nodes and data.

### The MMPO TOOLs

The MMPO TOOL component 535 is a stored program component that is executed by a CPU. In one embodiment, the MMPO TOOL component incorporates any and/or all combinations of the aspects of the MMPO TOOL that was discussed in the previous figures. As such, the MMPO TOOL affects accessing, obtaining and the provision of information, services, transactions, and/or the like across various communications networks. In one embodiment, the MMPO TOOL component 535 takes inputs (e.g., macro economic data 101, client data 102, etc.) and transforms the inputs via the Macro Economic Data Processing component 179, the Regression Component 174, the Forecast Data Generator component 176, and/or the like, into outputs (e.g., forecast structure 103, forecast data 105, etc.), as shown in FIGS. 1A, 3A-C, as well as throughout the specification.

The MMPO TOOL component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the MMPO TOOL server employs a cryptographic server to encrypt and decrypt communications. The MMPO TOOL component may communicate to and/or with other components in a component collection, including itself, and/or facilities of the like. Most frequently, the MMPO TOOL component communicates with the MMPO TOOL database, operating systems, other program components, and/or the like. The MMPO TOOL may contain, communicate, generate, obtain, and/or provide program component, system, user, and/or data communications, requests, and/or responses.

### Distributed MMPO TOOLs

The structure and/or operation of any of the MMPO TOOL node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the MMPO TOOL controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value₁

where Value₁ is discerned as being a parameter because “http://” is part of the grammar syntax, and what follows is considered part of the post value. Similarly, with such a grammar, a variable “Value₁” may be inserted into an “http://” post command and then sent. The grammar syntax itself may be presented as structured data that is interpreted and/or other wise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse communications data. Further, the parsing grammar may be used beyond message parsing, but may also be used to parse: databases, data collections, data stores, structured data, and/or the like. Again, the desired configuration will depend upon the context, environment, and requirements of system deployment.

The entirety of this application (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure.

As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A media marketing planning processor-implemented method, comprising:
obtaining macro economic data from a data source,
wherein the macro economic data comprises at least one of: gas prices, new housing starts, unemployment rate, prime interest rate, mortgage rate, S&P 500, consumer sentiment, M2 Money Stock and PMI Composite Index;
determining a set of significant economic indicators by testing multicolinearity of the received macro economic data; and
combining the set of significant economic indicators into at least one principal economic factor;
receiving client specific data, wherein the client specific data comprises: sales data, media spend data, and incentive/promotion data;
generating coefficients of a regression structure, based on the at least one principal economic factor and the received client specific data,
wherein sales data of the received client specific data serves as a dependent of the regression structure,
wherein the at least one principal economic factor and the rest of the received client specific data serve as regressors;
generating sales forecast data based on the established sales forecast structure by
determining a range of media spend and time period for forecasting,
calculating forecasted sales data of the range of media spend during the time period; and
generating client specific media marketing plan based on the generated sales forecast data, wherein the client specific media marketing plan comprises:
receiving a media spend budget from a user, and
determining the forecast sales based on the media spend budget.

2. A media marketing planning processor-implemented method, comprising:
obtaining macro economic data from a data source;
generating at least one principal economic factor from the obtained macro economic data;
receiving client specific data;
establishing a sales forecast structure by regression based on the at least one principal economic factor and the received client specific data;
generating sales forecast data based on the established sales forecast structure; and
generating client specific media marketing plan based on the generated sales forecast data.

3. The method of claim 2, wherein the macro economic data comprises at least one of: gas prices, new housing starts, unemployment rate, prime interest rate, mortgage rate, S&P 500, consumer sentiment, M2 Money Stock and PMI Composite Index.

4. The method of claim 2, wherein the data source comprises at least one of:
a internal database;
an external online database; and
a third party service provider.

5. The method of claim 2, wherein generating at least one principal economic factor from the obtained macro economic data comprises:
determining a set of significant economic indicators by testing multicolinearity of the received macro economic data; and
combining the set of significant economic indicators into at least one principal economic factor.

6. The method of claim 2, wherein the client specific data comprises: sales data, media spend data, and incentive/promotion data.

7. The method of claim 2, wherein establishing a sales forecast structure by regression based on the at least one principal economic factor and the received client specific data comprises:
generating coefficients of a regression structure, based on the at least one principal economic factor and the received client specific data,
wherein sales data of the received client specific data serves as a dependent of the regression structure,
wherein the at least one principal economic factor and the rest of the received client specific data serve as regressors.

8. The method of claim 2, wherein generating sales forecast data based on the established sales forecast structure comprises:
determining a range of media spend and time period for forecasting; and
calculating forecasted sales data of the range of media spend during the time period.

9. The method of claim 2, wherein generating client specific media marketing plan based on the generated sales forecast data comprises:
receiving a sales objective from a user; and
determining the required media spend to achieve the sales objective.

10. The method of claim 2, wherein generating client specific media marketing plan based on the generated sales forecast data further comprises:
receiving a media spend budget from a user; and
determining the forecast sales based on the media spend budget.

11. The method of claim 2, wherein generating client specific media marketing plan based on the generated sales forecast data further comprises:
calculating a return on media investment (ROMI) value associated with a media spend; and
determining a range of media spend with the most desirable ROMI values.

12. The method of claim 2 further comprises:
forecasting web visits data by a regression structure if Internet activity data is available.

13. The method of claim 12, wherein the regression structure comprises web visits data as a dependent, and media spend data, incentive data, and the principal economic factor as regressors.

14. The method of claim 2, further comprises:
determining a dollar value of each Internet activity based on the net contribution of the Internet activity to sales.

15. The method of claim 2, further comprises:
establishing a sales forecast structure for media spend of a specific media channel, if media spend data of the specific channel is available for regression; and
generating sales forecast data for media spend of the specific channel.

16. The method of claim 15, further comprises:
determining at least one allocation strategy of media spend between different media channels.

17. The method of claim 2, further comprises:
receiving data relating to a social media channel; and
establishing a sales forecast structure incorporating the received data relating to the social media channel as a regressor together with other client data.

18. The method of claim 17, wherein the social media channel comprises at least one of:
weblog, twitter information, an RSS feed, a blog, Facebook information, and MySpace Information.

19. The method of claim 2, further comprises:
sending the generated media marketing plan to at least one user.

20. A media marketing planning system, comprising:
means to obtain macro economic data from a data source;
means to generate at least one principal economic factor from the obtained macro economic data;
means to receive client specific data;
means to establish a sales forecast structure by regression based on the at least one principal economic factor and the received client specific data;
means to generate sales forecast data based on the established sales forecast structure; and
means to generate client specific media marketing plan based on the generated sales forecast data.

21. A media marketing apparatus, comprising:
a memory;
a processor disposed in communication with said memory, and configured to issue a plurality of processing instructions stored in the memory, wherein the processor issues instructions to:
obtain macro economic data from a data source;
generate at least one principal economic factor from the obtained macro economic data;
receive client specific data;
establish a sales forecast structure by regression based on the at least one principal economic factor and the received client specific data;
generate sales forecast data based on the established sales forecast structure; and
generate client specific media marketing plan based on the generated sales forecast data.

22. A processor-readable medium storing a plurality of processing instructions, comprising issuable instructions by a processor to:
obtain macro economic data from a data source;
generate at least one principal economic factor from the obtained macro economic data;
receive client specific data;
establish a sales forecast structure by regression based on the at least one principal economic factor and the received client specific data;
generate sales forecast data based on the established sales forecast structure; and
generate client specific media marketing plan based on the generated sales forecast data.
